(19) United States
(12) Patent Application Publication
(10) Pub. No.: US 2014/0104713 A1
(43) Pub. Date: Apr. 17, 2014

(54) FILTER WHEEL SYSTEM FOR COLOR CHANGING LIGHTING FIXTURES

(71) Applicant: PIXELTEQ, INC., LARGO, FL (US)

(72) Inventors: JAMES D. LANE, DUNEDIN, FL (US); STEVEN M. MATTESSICH, PALM HARBOR, FL (US)

(73) Assignee: PIXELTEQ, INC., LARGO, FL (US)

(21) Appl. No.: 14/053,810

(22) Filed: Oct. 15, 2013

Related U.S. Application Data
(60) Provisional application No. 61/715,029, filed on Oct. 17, 2012.

(51) Int. Cl. G02B 26/00

(52) U.S. Cl. CPC G02B 26/008
USPC 359/891

(57) ABSTRACT

A new color wheel filter system for color changing lighting fixtures is disclosed. More specifically it is a method of improving the filter wheel functionality through use of an improved filter wheel design by maximizing the filter clear aperture by directly bonding the filter glass substrate to a small hub bearing and moving the drive belt to the outside diameter. The filter wheel can also be constructed to allow easy interchanging of layered filter wheels on the color changing lighting fixture.

### CROSS-REFERENCE TO RELATED APPLICATION

The present application claims the benefit of previously filed co-pending Provisional Patent Application, Ser. No 61/715,029 filed Oct. 17, 2012.

### FIELD OF THE INVENTION

This invention belongs to the field of color changing optical devices. More specifically it is a method of improving the filter wheel functionality through use of an improved filter wheel design by maximizing the filter clear aperture by directly bonding the filter glass substrate to a small hub bearing and moving the drive belt to the outside diameter.

### BACKGROUND OF THE INVENTION

Filter wheels are used in many color changing systems. While these filter wheel systems perform well further improvements are warranted to advance the current state of the art in dichroic filter based color changing lighting fixtures in several areas.

By changing the construction of the filter wheel one can make significant improvements to optical performance of the filter wheel. Additional changes to the rotational drive mechanism allow optimization and synchronization between filter position and color changing timing.

### BRIEF SUMMARY OF THE INVENTION

The invention of this disclosure is a new filter wheel system for color changing lighting fixtures. More specifically it is a method of improving the filter wheel functionality through use of an improved filter wheel design by maximizing the filter clear aperture by directly bonding the filter glass substrate to a small hub bearing and moving the drive belt to the outside diameter. The filter wheel can also be constructed to allow easy interchanging of layered filter wheels on the color changing lighting fixture.

### BRIEF DESCRIPTION OF THE DRAWINGS

For a fuller understanding of the nature and objects of the invention, reference should be made to the following detailed description, taken in connection with the accompanying drawings, in which:

FIG. 1 is a front view of the color changing system with the new filter wheel system;

FIG. 2 is a side view of the color changing system with the new filter wheel system;

FIG. 3 is a cutaway side view of the color changing system with the new filter wheel system;

FIGS. 4 is a perspective view of the color drive assembly;

FIG. 5 is a perspective view of the edge drive filter wheel;

FIG. 6 is a side view of the mounting block;

FIG. 7 is a perspective view of the color wheel drive assembly and one edge of the mounting block while separated;

FIG. 8 is a perspective view of the color wheel drive assembly and one edge of the mounting block while joined; and,

FIG. 9 is a perspective view of the edge drive filter wheel.

### DESCRIPTION OF THE PREFFERED EMBODIMENT

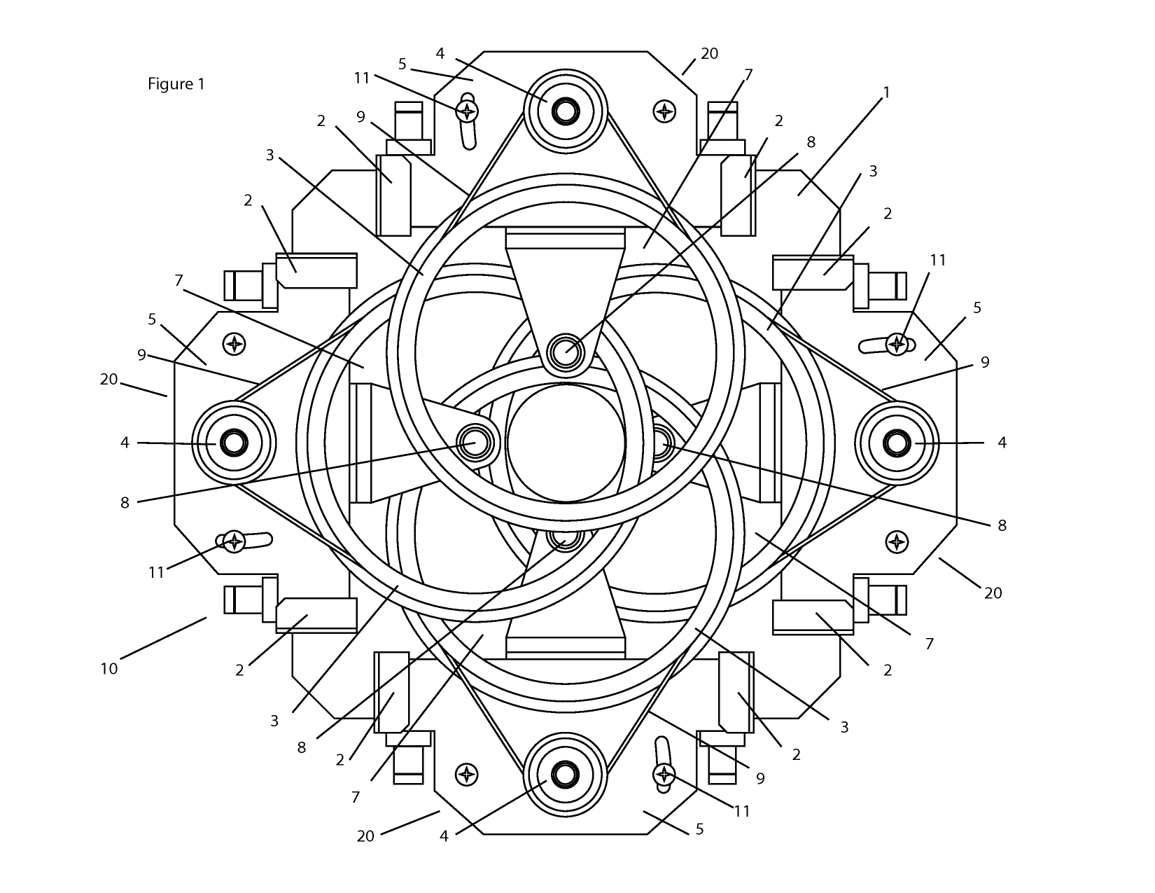

The preferred embodiment of the new color wheel filter system (10) for color changing lighting fixtures is shown in FIG. 1. In the preferred embodiment the color wheel filter system (10) comprises a square mounting block (1) style fixture for insertion into a color changing lighting system (10). The mounting block (1) has an optical beam path running from the back side through the center of the mounting block (1) and out the front side. The color wheel drive assemblies (20) are mounted on pairs of mounting pedestals (2) on the block (1) such that the color wheel drive assemblies (20) layer, one on top of the other, parallel to the front of the mounting block (1) and perpendicular to the optical beam path.

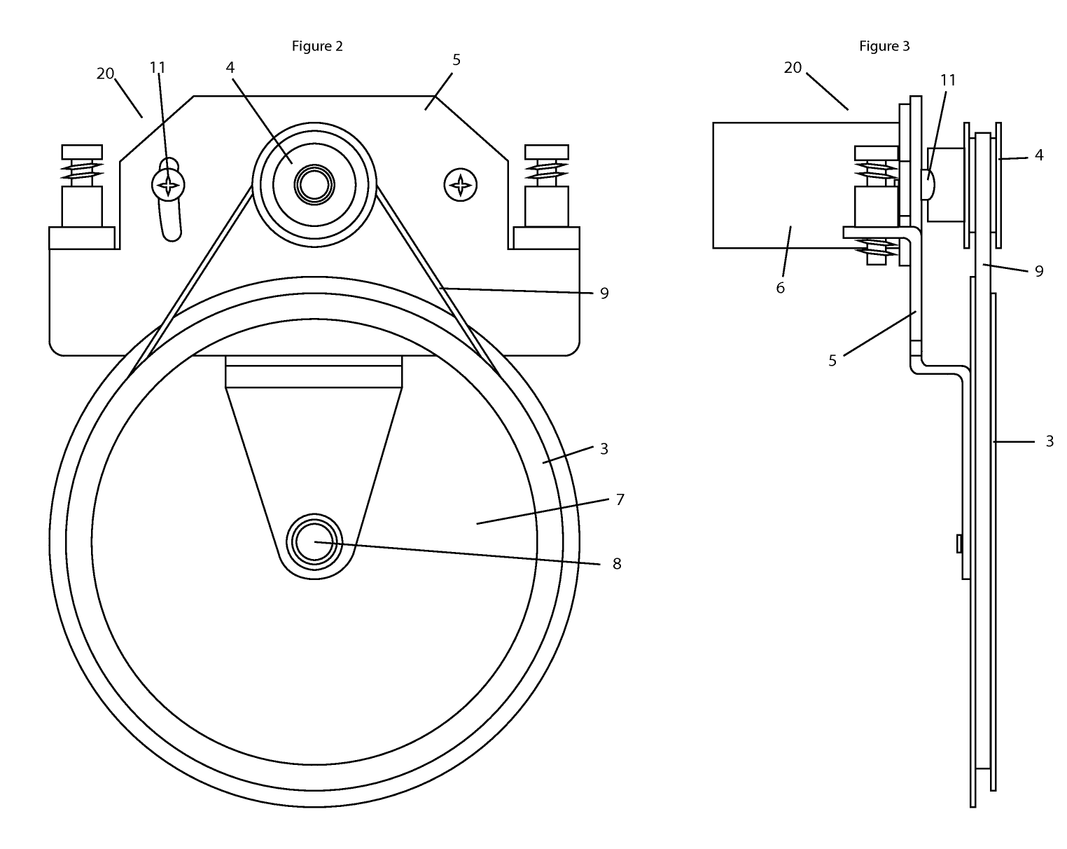

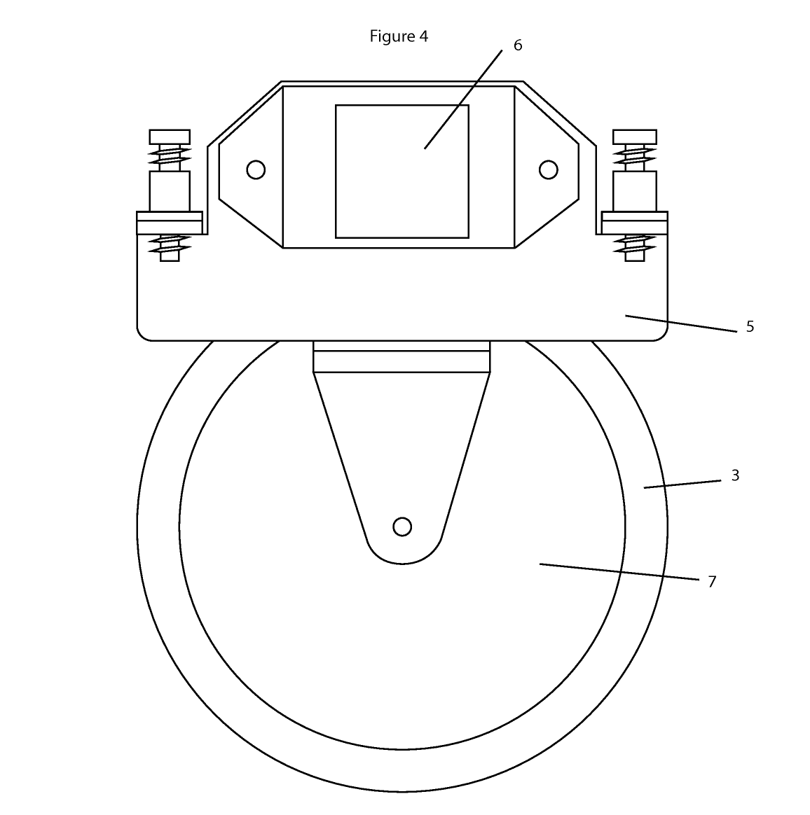

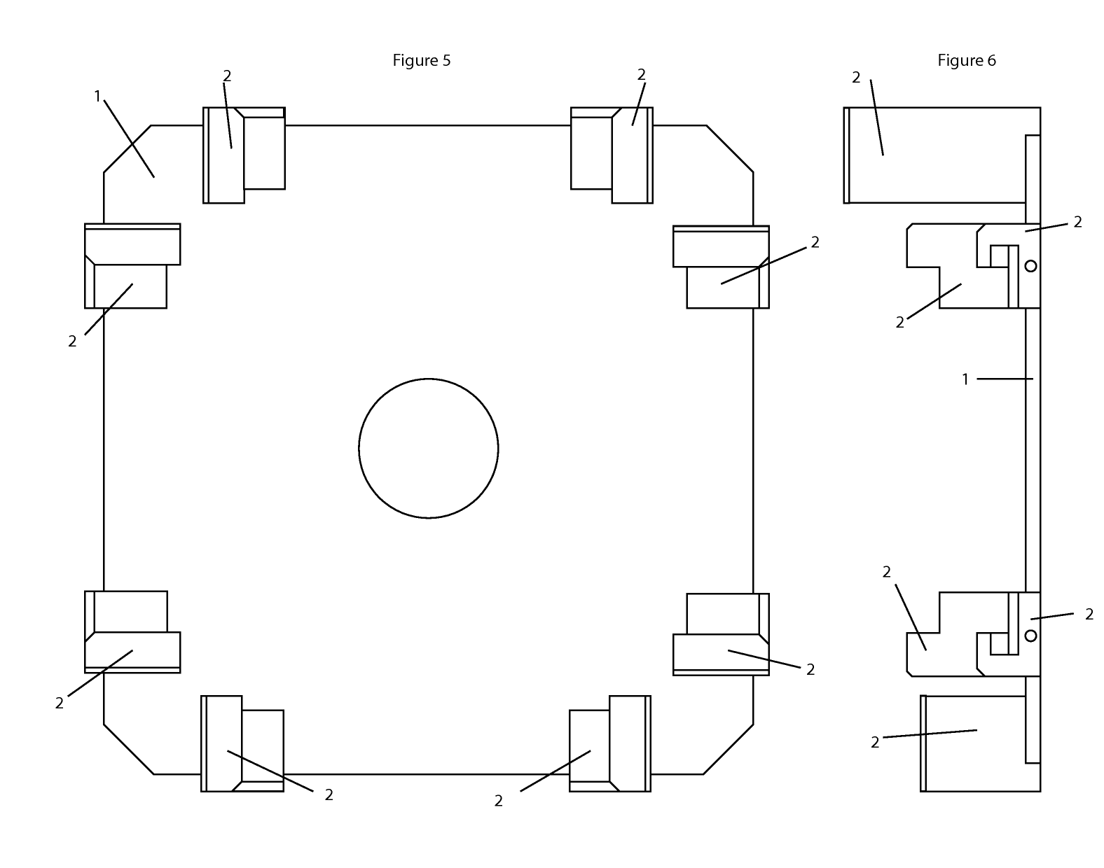

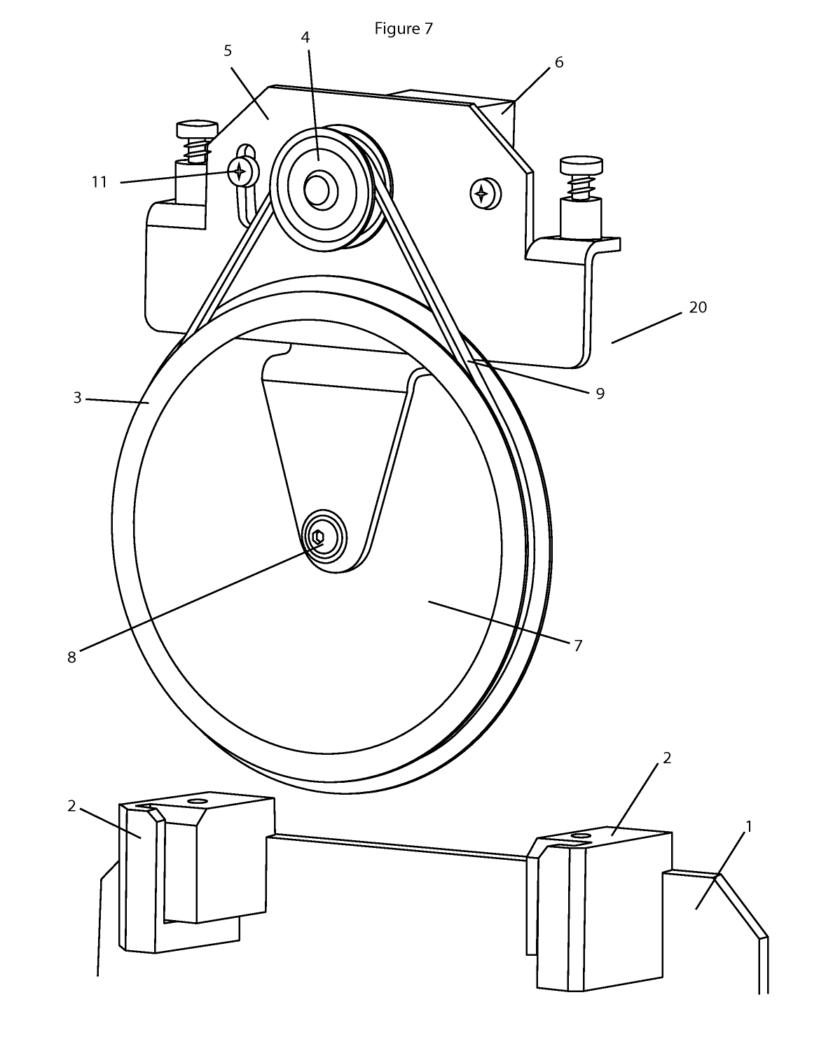

Each pair of mounting pedestals (2) are of varied heights, which allow for the layered configuration of the color wheel drive assemblies (20). The height variation of the mounting pedestals (2) can be can more easily be seen on the FIG. 6. FIGS. 2, 3, and 4 show the novel color wheel drive assembly (20) constructed with the filter wheel (3) and drive gear (4) and mounting bracket (5). An electric motor drive (6) (or other turning mechanism well known to those skilled in the art) attached to the mounting bracket (5) is illustrated most clearly in FIGS. 3 and 4. The placement of said motor drive (6) on the mounting bracket (5) allows for the color wheel drive assembly (20) to be mounted to the mounting pedestals (2) without interfering with the mounting block (1), clearly illustrated in FIG. 3. FIG. 7 shows in more detail the edge drive gearing (12) on the filter wheel (3).

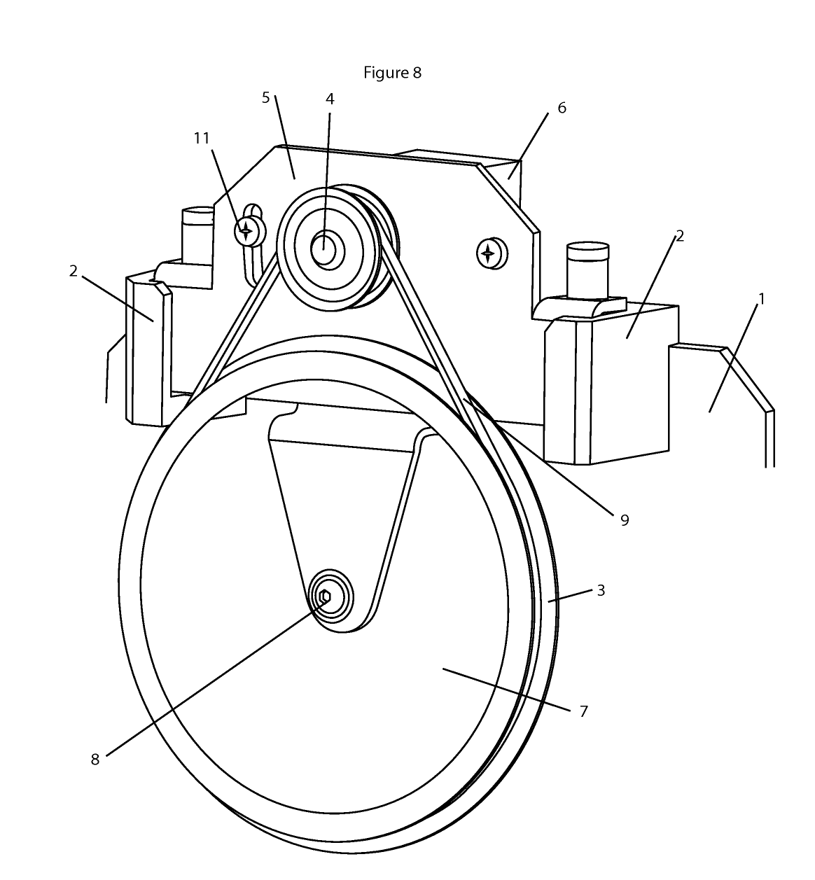

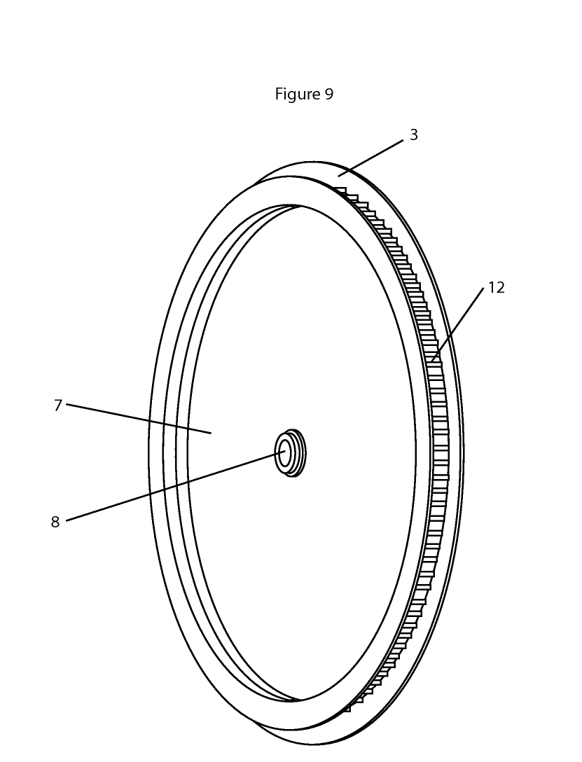

Mechanical improvements resulting from this new color wheel system (10) include reducing the diameter of the filter wheels (3) while maximizing the filter clear aperture by directly bonding the filter glass substrate (7) to a small hub bearing (8) and moving the drive belt (9) to the outside diameter of the filter wheel (3). Also a color wheel drive assembly (20) allows for each filter wheel (3) to be easily mounted along with all drive components for the filter wheel (3) on a single frame such as the mounting block (1). Additionally each color wheel drive assembly (20) can be rotationally mounted at any angle with respect to the optical beam path. Having no shared or interlocking components between any of the color wheel drive assemblies (20), any one of the color wheel drive assemblies (20) can be removed from the mounting block (1) and reinstalled individually without disturbing the others. FIG. 7 illustrates the color wheel drive assembly (20) detached from the mounting block (1), while FIG. 8 illustrates the color wheel drive assembly (20) and the mounting block (1) joined together via the mounting pedestals (2). This allows ease of access for customization of the installed filter set, and simplified field maintenance and support.

Optical improvements resulting from this new color wheel filter system (10) include the ability to position the color wheel drive assemblies (20) at any angle around the optical beam path, by adjusting the pivot screw (11) on the color wheel drive assembly (20), which means that typically used dichroic filter patterns on the filter wheel (3) can be aligned to reduce unwanted optical image artifacts. The pivot screw (11) can be clearly seen in FIGS. 2, 7, and 8. This angular pattern rotation greatly decreases the occurrence of Moire and “fringing” effects common with patterned dichroic color filters that share a common center shaft and beam path and also improves the homogenization of total mixed color through the combined dichroic color wheel drive assemblies (20) by allowing the saturation gradient directions of the filter wheels (3) to be non-parallel. The new design also reduces the intensity of combined reflected stray light off of the combined dichroic filters wheels (3) that can image on to the output optics and create image artifacts or aberrations.

Although the preferred embodiment discussed above describes this new color wheel system (10) in a rectangular configuration those skilled in the art can easily see that one can extend the number of color wheel drive assemblies (20) that can be mounted by the mounting block (1) to as few as one, and up to six, eight, or other multiples. Other embodiments can also include a triangular mounting plate with three color wheel drive assemblies (20), and maybe a hexagonal mounting plate with six color wheel drive assemblies (20). Since certain changes may be made in the above described improved color wheel filter system (10) for a color changing light fixture without departing from the scope of the invention herein involved, it is intended that all matter contained in the description thereof or shown in the accompanying figures shall be interpreted as illustrative and not in a limiting sense.

What is claimed is:

1. A color wheel filter system comprising:
one or more round filter glass substrates;
one or more hubs;
one or more edge gears;
each of said one or more hubs bonded to and at the center of each of said one or more round filter glass substrates; and,
each of said one or more edge gears bonded to the circumference of each of said one or more round filter glass substrates.

2. The color wheel filter system of claim 1 further comprising:
one or more drive assemblies;
each of said one or more drive assemblies having an extending offset arm attached to each of said one or more hubs bonded on and at the center of each of said one or more round filter glass substrates and allowing each of said one or more round filter glass substrates to rotate; and,
said one or more drive assemblies each having a drive gear mechanically attached to each of said one or more edge gears and rotating each of said one or more round filter glass substrates when each of said one or more drive gears rotates.

3. The color wheel filter system of claim 2 further comprising;
a mounting assembly;
wherein said one or more drive assemblies is removably attached to said mounting assembly; and,
wherein said one or more round filter glass substrates layer one over the other as each of said one or more drive assemblies is attached to said mounting assembly.

4. The color wheel filter system of claim 3 wherein said mounting assembly is a square faced mounting block having four sides and having an optical beam path running from the back face to the front face through the center of said square faced mounting block and wherein each of said one or more drive assemblies are removably attached to each of the sides of said square faced mounting block allowing the layering one of top of another of said round filter glass substrates parallel to the front of said mounting block and perpendicular to said optical beam path.
